(19) United States
(12) Patent Application Publication
(10) Pub. No.: US 2019/0131831 A1
(43) Pub. Date: May 2, 2019

(54) CORE ASSEMBLY FOR LINEAR MOTOR

(71) Applicant: HIWIN MIKROSYSTEM CORP., Taichung City (TW)

(72) Inventors: Liang-Cheng LU, Taichung City (TW); Chao-Chin TENG, Taichung City (TW)

(21) Appl. No.: 15/794,796

(22) Filed: Oct. 26, 2017

(51) Int. Cl. H02K 1/20

(52) U.S. Cl. CPC H02K 1/20

(57) ABSTRACT

A core assembly for the linear motor comprising a first core, a second core, a space, a tube division, a first assembly part and a second assembly part is provided. The first core comprises a first yoke, a first surface and a second surface wherein the first surface and the second surface are configured on the opposite sides of the first yoke, and a plurality of first teeth are configured on the second surface. The second core comprises a second yoke, a third surface and a fourth surface wherein the third surface and the fourth surface are configured on the opposite sides of the second yoke, the third surface corresponds to the first surface, and a plurality of second teeth are configured on the fourth surface. The space is formed between the first yoke and the second yoke. The tube division is contained within the space. The first assembly part and the second assembly part are positioned between the first surface and the third surface in the form of complementary configuration.

### BACKGROUND OF THE INVENTION

### Field of the Invention

The invention relates to a core assembly, and more particularly to a core assembly for the linear motor.

### Description of the Related Art

With respect to the cooling technology of the linear motor in the prior art, the patent CN103178687A disclosed the channels are configured on the corresponding surfaces of the two cores wherein the cooling tubes are located within the channels. The cooling system supplies the liquid media, such as water, oil, air or the combination thereof, into the cooling tubes for thermal conduction.

Although the above cooling technology provides the cooling effect by supplying the liquid media from outside cooling system, the lack of the assembly structure between the separate cores would deteriorate the connection between the core and the cooling tubes. Therefore, the thermal conduction path from the core to the liquid media through the channels is affected to decrease the cooling efficiency.

### SUMMARY OF THE INVENTION

In view of the disadvantages of prior art, the object of the present invention is to provide a core assembly for the linear motor to firmly assemble the cores whereby the cooling tubes is tightly held within the cores such that the thermal conduction is enhanced.

To achieve the above object, the present invention provides a core assembly for the linear motor comprising a first core, a second core, a space, a tube division, a first assembly part and a second assembly part. The first core comprises a first yoke, a first surface and a second surface wherein the first surface and the second surface are configured on the opposite sides of the first yoke, and a plurality of first teeth are configured on the second surface. The second core comprises a second yoke, a third surface and a fourth surface wherein the third surface and the fourth surface are configured on the opposite sides of the second yoke, the third surface corresponds to the first surface, and a plurality of second teeth are configured on the fourth surface. The space is formed between the first yoke and the second yoke. The tube division is contained within the space. The first assembly part and the second assembly part are positioned between the first surface and the third surface in the form of complementary configuration.

In one embodiment of the present invention, the tube division is contained within the space and between the first core and the second core such that the liquid media is fulfilled with the tube division for thermal conduction.

In one embodiment of the present invention, the first yoke and the second yoke are firmly connected through the engagement between the first assembly part and the second assembly part. The tube division is fastened against the first yoke and the second yoke closely to provide more contact area and increase the efficiency of the thermal conduction. In addition, the epoxy can be prevented from leaking into the gap between the tube division and the yoke to increase the efficiency of the thermal conduction.

In one embodiment of the present invention, the first assembly part and the second assembly part are complementary configuration in the form of the dovetail structure wherein the arrangement and the number thereof can be modified according to the requirement.

In one embodiment of the present invention, the first assembly part includes a plurality of indentations configured on the first surface and the third surface respectively and corresponding with each other. The second assembly part is embedded within the indentations. Through the engagement between the first assembly part and the second assembly part, the first core and the second core are firmly connected, and the module core with various sizes is also provided.

### BRIEF DESCRIPTION OF THE DRAWINGS

FIG. 1 is an exploded view of the core assembly according to the first embodiment of the present invention;

FIG. 2 is a schematic view of the core assembly according to the first embodiment of the present invention;

FIG. 3 is a cross sectional view of the core assembly along the line 3-3 of FIG. 2;

FIG. 4 is a plan view of the core assembly according to the second embodiment of the present invention;

FIG. 5 is a plan view of the core assembly according to the third embodiment of the present invention; and

FIG. 6 is a plan view of the core assembly according to the fourth embodiment of the present invention.

### DETAILED DESCRIPTION OF THE PREFERRED EMBODIMENTS

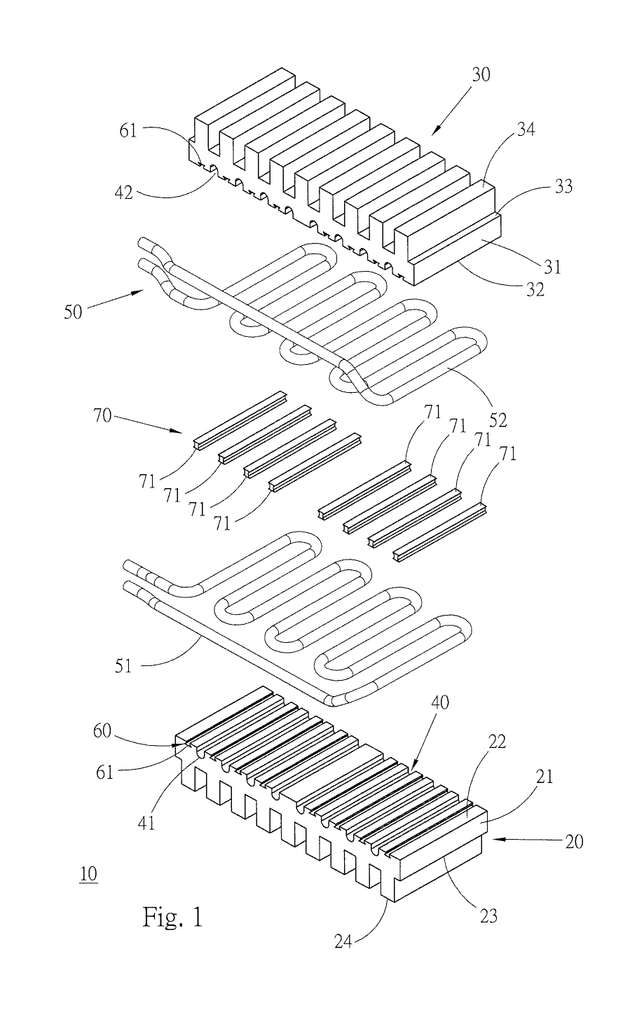

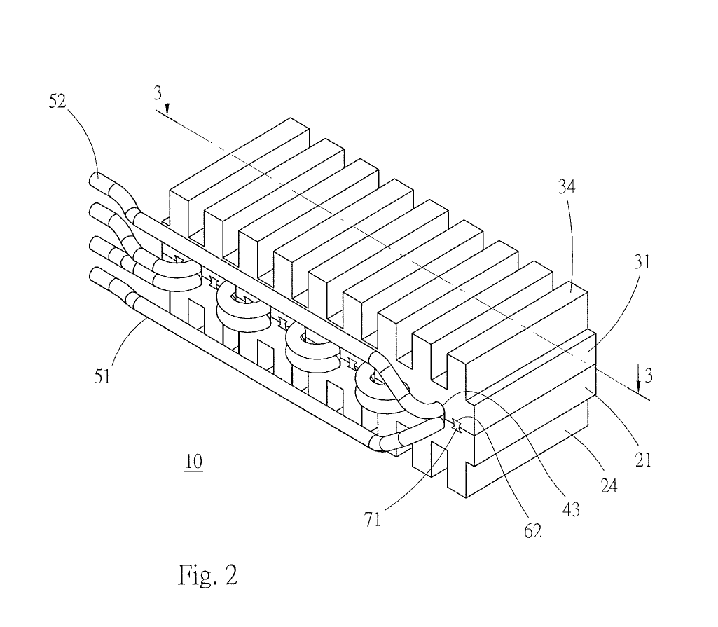

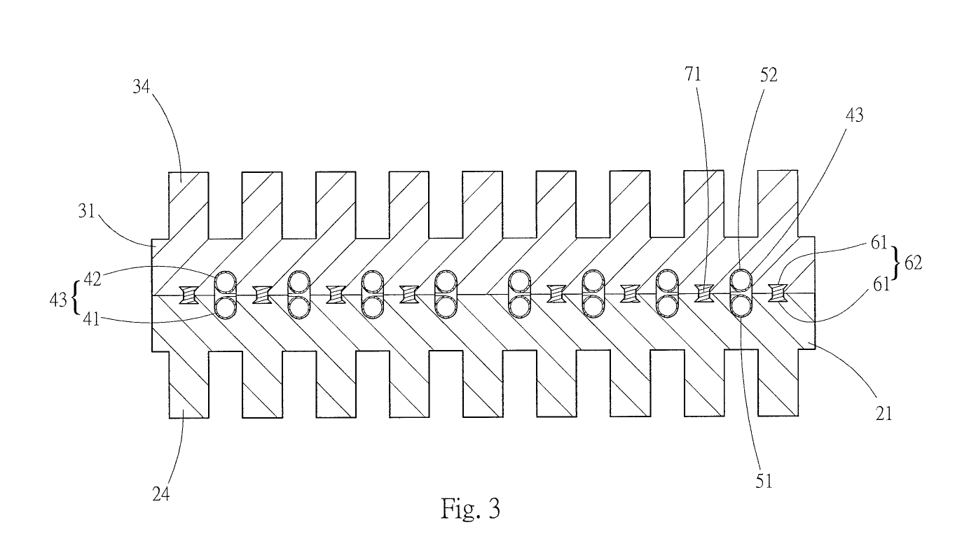

Refer to FIG. 1 to FIG. 3. The core assembly 10 for the linear motor includes a first core 20, a second core 30, a space 40, a tube division 50, a first assembly part 60 and a second assembly part 70.

The first core 20 and the second core 30 are made by stacking plural magnetic sheets. The first core 20 includes a first yoke 21 in the form of rectangular formation wherein a first surface 22 and a second surface 23 are configured on the opposite sides of the first yoke 20, and a plurality of first teeth 24 are configured on the second surface 23.

The second core 30 same as the structure of the first core 20 includes a second yoke 31 in the form of rectangular formation wherein a third surface 32 and a fourth surface 33 are configured on the opposite sides of the second yoke 31, and a plurality of second teeth 34 are configured on the fourth surface 33. The third surface 32 corresponds to the first surface 22, and the second teeth 34 are parallel to the first teeth 24.

The space 40 is formed between the first yoke 21 and the second yoke 31, and includes a plurality of first grooves 41 and a plurality of second grooves 42 configured on the first surface 22 and the third surface 32 respectively. The first grooves 41 extend along the orientation of the first teeth 24 and between the opposite ends of the first yoke 21. The second grooves 42 extend along the orientation of the second teeth 34 and between the opposite ends of the second yoke 31. The first grooves 41 correspond to the second grooves 42 to form a plurality of channels 43 between the first surface 22 and the third surface 32.

The tube division 50 includes two conduits 51/52 set within the first grooves 41 and the second grooves 42 respectively, and corresponding with each other in the channels 43. The inlets and outlets of the conduits 51/52 are positioned outside the first core 20 and the second core 30 to connect with the source of the cooling media.

The first assembly part 60 includes a plurality of indentations 61 configured between the first grooves 41 on the first surface 22 and between the second grooves 42 on the third surface 32 respectively. The indentations 61 are in the form of the dovetail structure, and correspond with each other to form a plurality of passages 62 between the first yoke 21 and the second yoke 31.

The second assembly part 70 includes a plurality of locking units 71 in the form of H-shaped bars and complementary to indentations 61 such that the locking units 71 are embedded within the passages 62.

Accordingly, the first yoke 21 and the second yoke 31 are firmly connected through the engagement between the first assembly part 60 and the second assembly part 70. The conduits 51/52 set within the channels 43 are fastened against the first yoke 21 and the second yoke 31 closely to provide more contact area and increase the efficiency of the thermal conduction.

The cooling media contained within the conduits 51/52 is provided from the outside source to cool the windings (not shown) on the first teeth 24 and the second teeth 34. The relationship between the winding temperature and the flow direction is illustrated as the following chart. In the condition the flow rate is 1.5 L/min and the thermal power of the winding is 3350 W, the temperature difference is 10.58° C. under the same flow direction and the temperature difference is 8.05° C. under the reverse flow direction. In another condition the flow rate is 3 L/min and the thermal power of the winding is 4900 W, the reverse flow direction means also provides lower temperature difference such that the reverse flow direction means could enhance cooling efficiency.

| | 1.5 L/min, 3350 W | | 3 L/min, 4900 W | |
|---|---|---|---|---|
| | Same flow | Reverse flow | Same flow | Reverse flow |
| | direction | direction | direction | direction |
| Highest | 119.56° C. | 117.16° C. | 121.49° C. | 119.93° C. |
| winding | | | | |
| temperature | | | | |
| Average | 108.98° C. | 109.11° C. | 108.77° C. | 108.96° C. |
| winding | | | | |
| temperature | | | | |
| Temperature | 10.58° C. | 8.05° C. | 12.72° C. | 10.97° C. |
| difference | | | | |

Therefore, the first core 20 is connected with the second core 30 through the embedment between the first assembly part 60 and the second assembly part 70. Furthermore, the first assembly part 60 and the second assembly part 70 can be formed as two individual units or as a whole with the first yoke 21 and the second yoke 31.

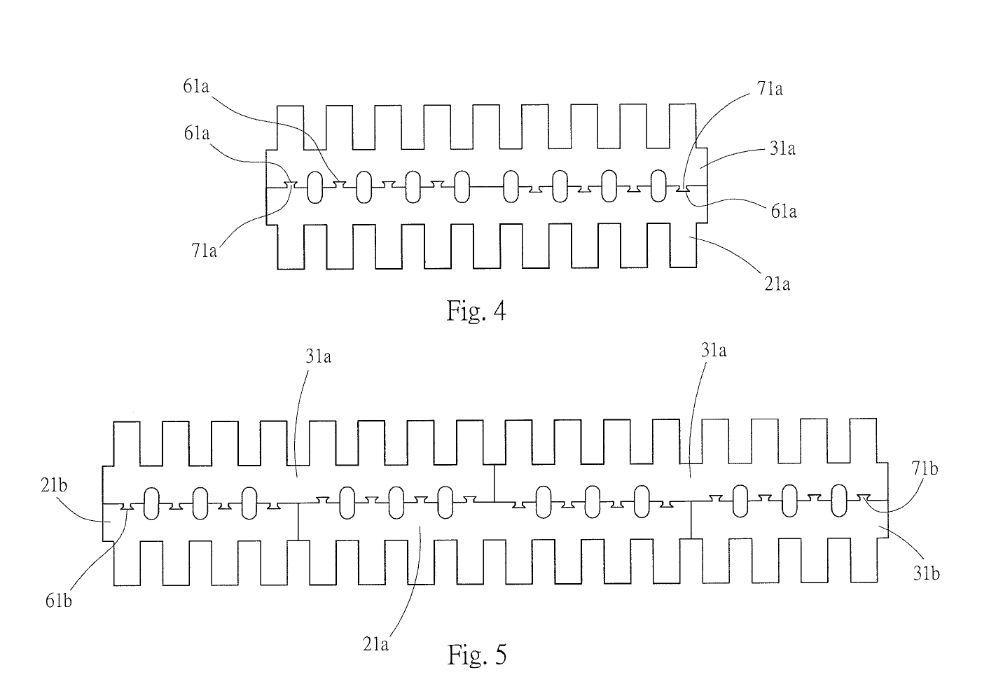

Refer to FIG. 4 illustrating the second embodiment of the present invention. The first assembly part 60 includes a plurality of indentations 61a in the form of the dovetail structure and configured as a part of the first yoke 21a and the second yoke 31a respectively. The second assembly part 70 includes a plurality of locking units 71a in the form of the dovetail structure and configured as a part of the first yoke 21a and the second yoke 31a.

Refer to FIG. 5 illustrating the third embodiment of the present invention. The first assembly part 60 includes a plurality of indentations 61b in the form of the dovetail structure and configured as a part of the first yoke 21b. The second assembly part 70 includes a plurality of locking units 71b in the form of the dovetail structure and configured as a part of the second yoke 31b. Moreover, the connection of the first core 20 and the second core 30 can adopt the second embodiment and the third embodiment depending on the requirement to provide flexibility of the assembly.

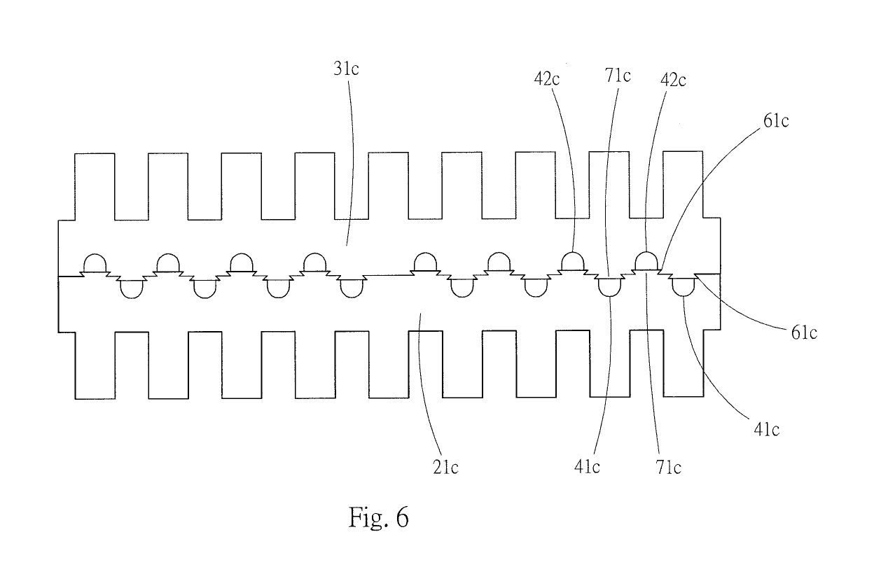

Refer to FIG. 6 illustrating the fourth embodiment of the present invention. The first assembly part 60 includes a plurality of indentations 61c in the form of the dovetail structure and configured as a part of the first yoke 21c and the second yoke 31c respectively. Specifically, the indentations 61c are configured on the first grooves 41c and the second grooves 42c. The second assembly part 70 includes a plurality of locking units 71c in the form of the dovetail structure and configured as a part of the first yoke 21c and the second yoke 31c. Specifically, the locking units 71c of the first yoke 21c are configured between the first grooves 41c, and the locking units 71c of the second yoke 31c are configured between the second grooves 42c.

What is claimed is:

1. A core assembly for the linear motor, comprising:
a first core, comprising a first yoke, a first surface and a second surface wherein the first surface and the second surface are configured on the opposite sides of the first yoke, and a plurality of first teeth are configured on the second surface;
a second core, comprising a second yoke, a third surface and a fourth surface wherein the third surface and the fourth surface are configured on the opposite sides of the second yoke, the third surface corresponds to the first surface, and a plurality of second teeth are configured on the fourth surface;
a space, formed between the first yoke and the second yoke;
a tube division, contained within the space; and
a first assembly part and a second assembly part, positioned between the first surface and the third surface in the form of complementary configuration.

2. The core assembly for the linear motor as claimed in claim 1, wherein the space comprises a plurality of first grooves and a plurality of second grooves configured on the first surface and the third surface respectively.

3. The core assembly for the linear motor as claimed in claim 2, wherein the first grooves correspond to the second grooves to form a plurality of channels between the first surface and the third surface.

4. The core assembly for the linear motor as claimed in claim 2, wherein the first grooves corresponds to the second core and the second grooves correspond to the first core to form a plurality of channels between the first surface and the third surface.

5. The core assembly for the linear motor as claimed in claim 4, wherein the first assembly part comprises a plurality of indentations corresponding to the first grooves.

6. The core assembly for the linear motor as claimed in claim 5, wherein the first teeth are parallel with each other and the indentations are parallel with the first teeth.

7. The core assembly for the linear motor as claimed in claim 2, wherein the first teeth are parallel with each other and the first grooves are parallel with the first teeth, and the second teeth are parallel with each other and the second grooves are parallel with the second teeth.

8. The core assembly for the linear motor as claimed in claim 1, wherein the first assembly part and the second assembly part are disposed on the first surface and the third surface respectively.

9. The core assembly for the linear motor as claimed in claim 1, wherein the first assembly part comprises two indentations configured on the first surface and the third surface respectively and corresponding with each other, and the second assembly part is embedded within the indentations.

10. The core assembly for the linear motor as claimed in claim 5, wherein the indentations are in the form of the dovetail structure.

11. The core assembly for the linear motor as claimed in claim 9, wherein the indentations are in the form of the dovetail structure.
